(19) United States
(12) Patent Application Publication
(10) Pub. No.: US 2015/0096481 A1
(43) Pub. Date: Apr. 9, 2015

(54) AGRICULTURAL MATERIAL APPLICATOR

(71) Applicant: Terry S. Glendenning, Churdan, IA (US)

(72) Inventor: Terry S. Glendenning, Churdan, IA (US)

(21) Appl. No.: 14/049,756

(22) Filed: Oct. 9, 2013

(51) Int. Cl. A01B 49/06; A01C 5/06

(52) U.S. Cl. CPC A01B 49/06; A01C 5/068
USPC 111/120; 111/190; 111/192; 111/195; 111/193

(57) ABSTRACT

An agricultural material applicator is disclosed herein. The applicator uses a coulter, a knife, and a dual sealer assembly to provide agricultural material such as liquid manure to the soil. Weight of the agricultural material applicator is supported by the sealer assembly to eliminate the need for additional gauge wheels. The sealer assembly is two sealers provided with independent suspension to allow one sealer to move out of the way of an obstruction, while the other sealer continues to operate.

### TECHNICAL FIELD

The present invention relates, in general, to an agricultural implement for applying material to soil and, more particularly, to a system for distributing weight of an agricultural material applicator to sealing coulters.

### DESCRIPTION OF THE BACKGROUND ART

There are many styles of agricultural material applicators. Such devices include a combination of soil disrupters that cut into the soil, actual material applicators that apply material to the soil, and sealers that place soil over the area to which the material has been applied. Such devices typically balance the load of the applicator on gauge wheels or similar devices to distribute the weight of the applicator away from the crop row to which the material is being applied.

It is known in the art to provide a toolbar with coulters, knives, and sealers to open up the soil, apply a material such as nutrient liquid manure, and seal the area to which the manure was applied. Sealing the soil reduces excess noxious fumes associated with the application and prevents the nutrient from being washed away from the soil. One drawback associated with such prior art devices is the unevenness of the depth to which the material is applied. As prior art toolbars move over uneven ground, the soil disrupters, knives, and sealers contact the soil with differing pressures. This leads to the material being applied at differing depths and being sealed into the soil with differing efficiencies.

It is known in the art to provide toolbars with gauge wheels to provide the soil disrupters, knives, and sealers at a consistent depth. While prior art gauge wheels assist in providing material to the soil at a consistent depth when working over even terrain, such systems are subject to variances in terrain that lead to material being applied at too deep or too shallow depth, since the individual material application systems applying the material are unable to sufficiently respond to varying terrain. It would therefore be desirable to provide a system for applying a material to the soil that allows for each material application system to independently adjust for varying terrain. It would also be desirable to provide a system for applying a material to the soil that eliminates the need for additional gauge wheels.

It is also known in the art to provide material to the soil using fixed systems to reduce the chance of soil sealers not adequately providing soil over the area to which the material has been applied. One drawback associated with such prior art systems is the fixed nature of the toolbar.

Individual systems allow vibrations associated with the application process to prematurely wear the systems and increase the maintenance and replacement costs associated therewith.

Therefore, what is needed in the art is a system that applies material to the soil at a consistent rate over varying terrain systems and that reduces repair and replacement costs associated with vibration associated with the application process.

### SUMMARY OF THE DISCLOSED SUBJECT MATTER

A system for applying material to soil is provided with a frame. Coupled to the frame are a soil disrupter, a soil sealer, and a material dispenser. The material dispenser is positioned between the soil disrupter and soil sealer and is in alignment therewith. A depth stabilizer is coupled to the soil sealer and is of a construction sufficient to prevent the soil sealer from penetrating the soil beyond a predetermined depth.

A system for applying material to soil is disclosed herein. One aspect of the material application system relates to providing a system for applying material to soil with a depth stabilizer coupled to a soil sealer.

Another aspect of the material application system relates to improved sealing of material under the soil.

Another aspect of the material application system relates to reduced plugging of sealers sealing material under the soil.

Another aspect of the material application system relates to a system for providing material to the soil at a predetermined depth in uneven terrain.

Another aspect of the material application system relates to providing soil sealers with independent suspension systems.

Another aspect of the material application system relates to supporting the system on the soil sealers.

Another aspect of the material application system relates to reducing maintenance and replacement costs associated with rigidly fixed material application systems.

These and other aspects will be more readily understood by reference to the following description and figures.

### BRIEF DESCRIPTION OF THE DRAWINGS

The present invention will now be described, by way of example, with reference to the accompanying drawings in which:

FIG. 1 illustrates a rear elevation of the agricultural material applicator of the present invention coupled to an agricultural vehicle;

FIG. 2 illustrates a top elevation of the agricultural material applicator of FIG. 1;

FIG. 3 illustrates a side perspective view of the agricultural material applicator of FIG. 1;

FIG. 4 illustrates a top perspective view of one material applicator assembly of the agricultural material applicator of FIG. 1;

FIG. 5 illustrates a side perspective view of the knife assembly of the material applicator assembly of FIG. 4; and

FIG. 6 illustrates a top perspective view of the material applicator assembly of FIG. 1.

### DETAILED DESCRIPTION OF THE DRAWINGS

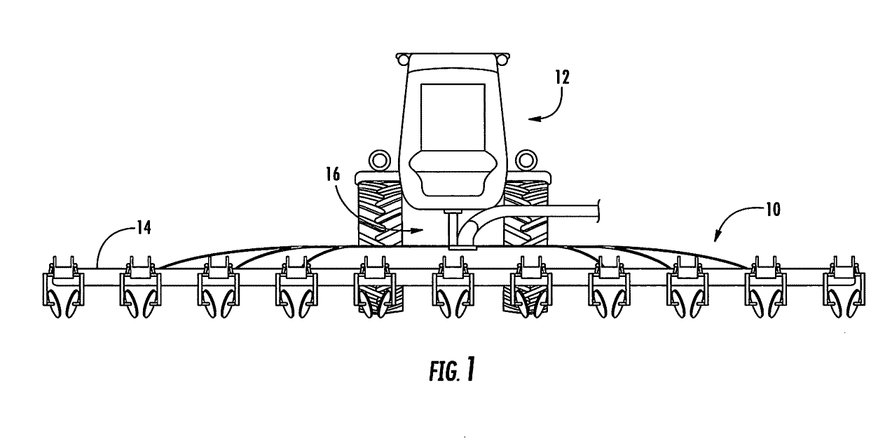

An agricultural material applicator is shown generally as 10 in FIG. 1. The embodiments of the invention described below are illustrated only and are not to be interpreted as limiting the scope of the present invention.

The agricultural material applicator 10 is coupled to a tractor 12 or similar vehicle capable of pulling or pushing the material applicator 10. The agricultural material applicator 10 includes a frame 14 which may be constructed of tubular steel having a square cross section or may be constructed of any materials known in the art (FIGS. 1-3). The frame 14 is coupled to the tractor 12 by three-point hitch 16, such as those known in the art. The three-point hitch preferably includes an upper link 18, a first draft link 20, and a second draft link 22. The hitch 16 may be of any type known in the art, but is preferably of a type that lifts an agricultural implement during transport.

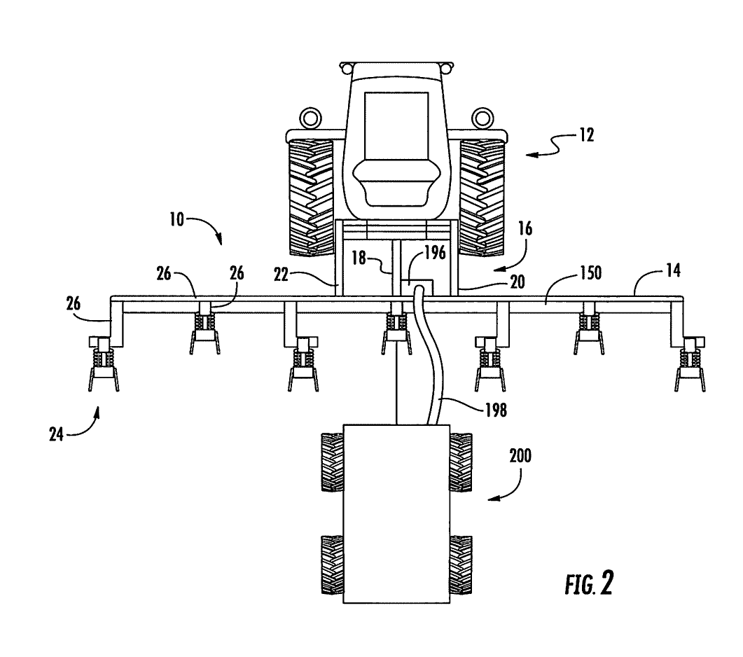

As shown in FIG. 2, coupled to the frame 14 is a plurality of applicator assemblies 24. The applicator assemblies preferably weigh between 100 and 1,000 pounds apiece, more preferably between 200 and 600 pounds apiece, and most preferably between 400 and 500 pounds apiece. The applicator assemblies 24 may be coupled directly to the frame 14 or may be coupled to extension bars 26 welded or otherwise secured to the frame 14. The extension bars 26 are preferably provided to stagger the applicator assemblies 24 to allow debris and other material to pass more easily between the applicator assemblies 24. To couple the applicator assemblies 24 to either the frame 14 or to the extension bars 26, a steel collar 28 is provided around the frame 14 or extension bar 26 and secured through the applicator assembly 24 by bolts 30 in a manner such as that known in the art. While the applicator assemblies 24 may be welded to the frame 14 and extension bars 26, the applicator assemblies 24 are preferably releasably secured to the frame 14 and extension bars 26 by the collars 28 and the extension bars 26 are preferably releasably secured to the frame 14 to allow the applicator assemblies 24 to be removed for repair or replacement and to adjust the distance between the applicator assemblies 24 for agricultural rows of different widths.

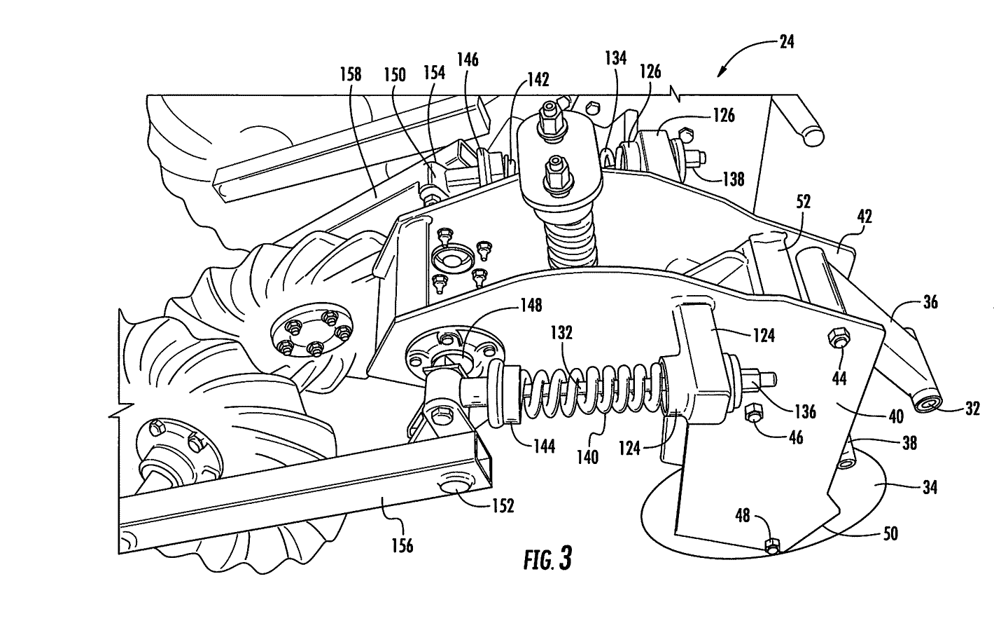

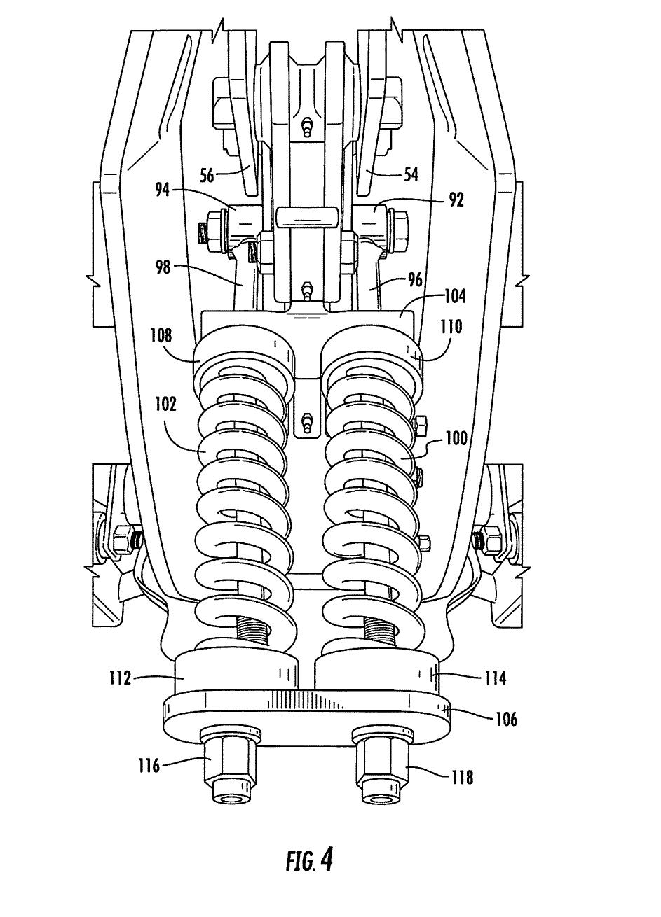

As the applicator assemblies 24 are generally of a similar construction, description will be limited to a single applicator assembly 24. Pivotably secured to the collars 28, by a pair of pins, 32, 34, are a pair of steel plates 36, 38 (FIGS. 3-4). The plates 36, 38 are coupled to a pair of side plates 40, 42, by another pair of pins 44, 46, in a parallel linkage arrangement that allows the applicator assembly 24 to move up and down relative to the tractor 12, while remaining parallel thereto. The steel plates 36, 38 and side plates 40, 42 are preferably constructed of ½″ thick steel plate.

As shown in FIGS. 3-4, journaled to the side plates 40, 42 by an axle 48, is a coulter 50. While in the preferred embodiment a coulter 50 is used, any type of soil disrupter, such as a knife, a plow, molboard, or any other type of soil disrupter known in the art may be used. The weight of the applicator assembly 24 is preferably sufficient to bias the coulter 50 to enter the soil a desired depth, while not being so great as to prevent the coulter 50 from tilting the entire applicator assembly 24 upward via the parallel linkage of the steel plates 36, 38 upon contact with an obstruction, such as a rock, to prevent damage to the coulter 50 or other parts of the applicator assembly 24.

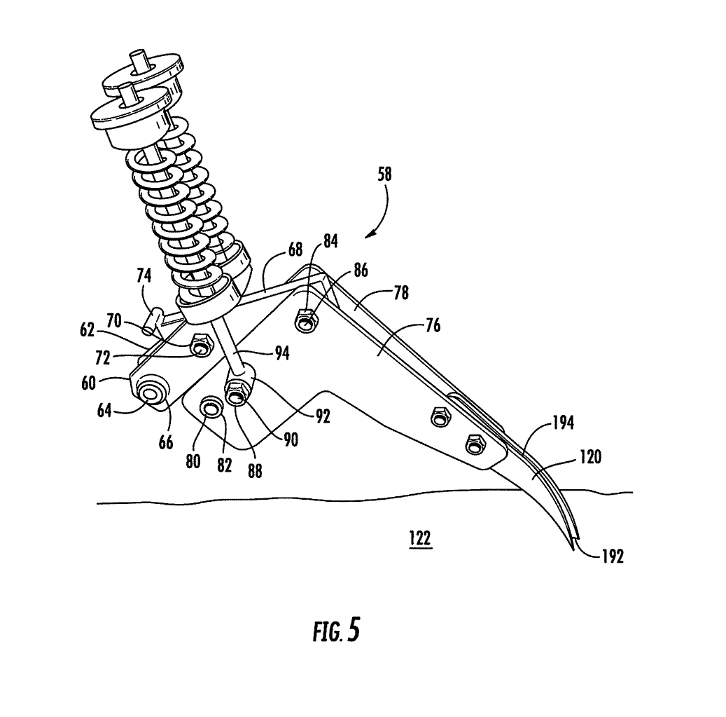

As shown in FIGS. 3, 4, and 5, a pair of depending support plates 64, 66 are bolted or otherwise secured to the knife plates 58, 60. Secured between the support plates 64, 66 is a steel spacer 68 secured to the support plates 64, 66 by bolts 70, 72. Welded or otherwise secured to the support plates 64, 66 is a steel bar 74 through which is provided two steel rods 76, 78. The side plates 40, 42 are welded to one another by a crossbar 52. Welded to the crossbar 52 are two mounting plates 54, 56. Shown in FIG. 5 is a knife assembly 58, which has a pair of shoulder plates 60, 62, coupled together by a sleeve 64, provided through holes 66 in the shoulder plates 60, 62. Provided between the shoulder plates 60, 62, is a steel rocker arm 68. The rocker arm 68 is pivotably secured to the shoulder plates 60, 62 by a nut 70 and bolt 72. A small steel bar 74 is welded to the rocker arm 64 to act as a stop to prevent the rocker arm 64 from rotating too much relative to the shoulder plates 60, 62.

As shown in FIG. 5, two steel knife plates 76, 78 are coupled together by a sleeve 80, provided through holes 82 in the knife plates 76, 78. The knife plates 76, 78 are pivotably coupled to the rocker arm 68 by a nut 84 and bolt 86. A nut 88 and bolt 90 are provided through the knife plates 76, 78 and eyelets 92, 94 of a pair of steel shafts 96, 98, to pivotably couple the steel shafts 94 to the knife plates 76, 78.

Provided around the shafts 96, 98 are a pair of steel springs 100, 102. The springs 100, 102 are contained by two cylinder plates 104, 106 provided over the shafts 96, 98. The cylinder plates 104, 106 preferably have short steel cylinders 108, 110, 112, 114 welded to them to contain the springs 100, 102. Nuts 116, 118 are provided on the shafts 96, 98 to contain the plate 106 and preferably maintain the springs 100, 102 under tension. The lower plate 104 is welded to the rocker arm 68. Bolted to the bottom of the knife plates 76, 78 is a knife 120, such as those well known in the art. If desired, any type of soil disrupter such as a plow, molboard or any other type of soil disrupter may be secured to the knife plates 76, 78. Preferably, the knife 120 is releasably secured to the knife plates 76, 78 to allow for replacement and repair of the knife 120.

The knife assembly 58 is pivotably coupled to the mounting plates 54, 56 by a pair of nuts 122, 124 and bolts 126, 128 passing through the steel sleeves 64, 80. The springs 100, 102 allow the knife 120 to tilt upward and rearward when the knife 120 encounters a rock, or other obstruction that may damage the knife 120. Once the knife 120 has passed the obstruction, the springs 100, 102 bias the knife 120 back into the ground 122. The tension on the springs 100, 102 may be adjustable, to change the bias on the knife 120, depending upon the type of knife and environmental conditions. Additionally, the resilient nature of the springs 100, 102 reduces the likelihood of vibration of the agricultural material applicator damaging the knife 120 during use.

As shown in FIG. 3, steel ears 124, 126 are welded to the side plates 40, 42. The steel ears 124, 126 are each provided with a short cylinder 128, 130 welded thereto. Provided through holes in the ears 124, 126 are a pair of steel shafts 132, 134. The shafts 132, 134 are secured to the ears 124, 126 by bolts 136, 138. Provided over the shafts 132, 134 and provided within the short cylinders 128, 130, are a pair of springs 140, 142. Provided over the shafts 132, 134 and containing the springs 140, 142 are a pair of cylinder stops 144, 146. The cylinder stops 144, 146 abut eyelets 148, 150 provided on the ends of the shafts 132, 134.

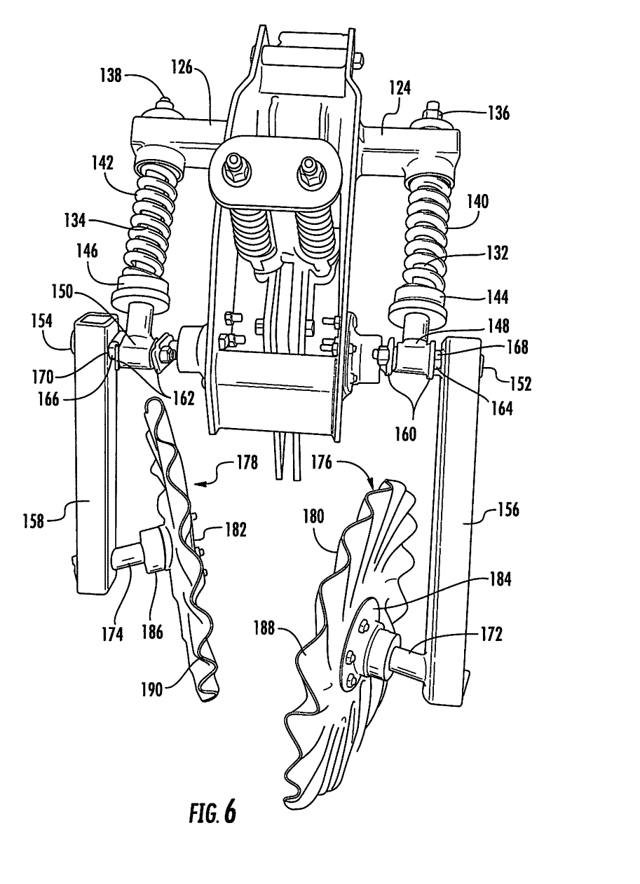

Journaled to the side plates 40, 42 by a pair of axles 152, 154, is a pair of drop bars 156, 158 (FIGS. 3 and 6). Welded to the drop bars 156, 158 are two pairs of steel shoulders 160, 162. The steel shoulders 160, 162 surround the eyelets 148, 150 provided on the ends of the shafts 132, 134, and are pivotably secured thereto by a pair of nuts 164, 166 and bolts 168, 170. Welded to the drop bars 156, 158 are angled axles 172, 174. Journaled to the angled axles 172, 174 are two coulter sealers 176, 178. While any type of coulter sealer sufficient to move soil over the area disrupted by the coulter 50 may be attached to the angled axles 172, 174, in the preferred embodiment, the coulter sealers 176, 178 are directional spiral coulters 180, 182, such as those well-known in the art, provided with a wavy construction, approximately one inch in width. In the preferred embodiment, the two coulter sealers 176, 178 are Vortex 20″ coulters, part number V20236, manufactured by Wiese Industries, Inc. 1501 5th Street, Perry, Iowa 50220.

The width of the waves may of course be adjusted to accommodate varying soil conditions and other factors to achieve the desired depth of the knife 120 into the soil.

In normal soil conditions, the rear coulter sealer 176 is run in a “riding” orientation, with the inner body of the spiral waves contacting the soil before the outer edge of the spiral waves contact the soil, while the front coulter sealer 178 is run in a “digging” orientation, with the outer edge of the spiral waves contacting the soil before the inner body of the spiral waves contact the soil. In drier soil conditions, both of the coulter sealers 176, 178 may be run in the digging orientation to more aggressively seal the soil. In wetter soil conditions, both of the coulter sealers 176, 178 may be run in the riding orientation to more prevent coulter sealers 176, 178 from getting stuck or clogged.

If desired the coulter sealers 176, 178 are journaled to the angled axles 172, 174 by bearings or any other means known in the art to allow the coulter sealers 176, 178 to rotate relative to the angled axles 172, 174. The coulter sealer 176 is preferably offset forward of the coulter sealer 178 preferably by between one and one hundred inches, more preferably between three and fifty inches, and most preferably between six and twenty inches. Preferably, the coulter sealers 176, 178 are offset enough to reduce plugging between the coulter sealers 176, 178, but not so much as to allow the coulter sealer 176 to direct a significant of soil beyond the coulter sealer 178. Offsetting the coulter sealers 176, 178 and providing them at an angle allows the coulter sealers 176, 178 to dig into the soil and funnel soil toward the space between the coulter sealers 176, 178 to provide soil over the area disrupted by the coulter 50, while reducing plugging of soil and debris between the coulter sealers 176, 178. The waves in the coulter sealers 176, 178 are sufficiently wide to allow the entire weight of the applicator assembly 24 to rest on the coulter sealers 176, 178 without the coulter sealers 176, 178 digging into the soil an undesirable depth. This also allows the coulter sealers 176, 178 to prevent material from building up in front of the coulter sealers 176, 178.

This arrangement allows the springs 140, 142 to allow the coulter sealers 176, 178 to independently tilt upward and rearward when the knife coulter sealers 176, 178 encounter a rock or other obstruction that may damage the coulter sealers 176, 178. Once a coulter sealer 176, 178 has passed the obstruction, the springs 140, 142 bias the coulter sealer 176, 178 back into the ground 122. The tension on the springs 140, 142 may be adjustable, by loosening or tightening nuts 136, 138 screwed onto the shafts 132, 134 to change the bias on the coulter sealers 176, 178, depending upon the type of coulter sealers 176, 178 and environmental conditions.

As shown in FIGS. 3-4, a nozzle 192 is secured behind the knife 120 to allow the application of liquid manure or similar material, such as another nutrient, herbicide, or pesticide to be inserted into a furrow created by the coulter 50 and/or knife 120. The nozzle 192 may be adjustable and may be positioned any desired height above the soil or may, alternatively, be positioned below the soil surface, if desired. The nozzle 192 is coupled to a hose 194, which provides the material to the nozzle 192. The hose 194 is preferably coupled to a pump 196 provided on the frame 14 and coupled via another hose 198 to a tank trailer 200 or other material container to supply the nozzle 192 with material to be applied to the soil (FIG. 2).

When it is desired to use the agricultural material applicator 10 of the present invention, the applicator 10 is coupled to a tractor 12, which in turn, is coupled to the tank trailer 206. Each individual applicator assembly 24 is adjusted by tightening or loosening the nuts 116, 118, coupled to the shafts 96, 98, and nuts 136, 138 coupled to shafts 132, 134.

In the preferred embodiment, the entire weight of the agricultural material applicator 10 rests on the applicator assemblies 24, with the majority of the weight resting on the coulter sealers 176, 178. Preferably, between 25% and 100% of the weight resting on the coulter sealers 176, 178, and between 0% and 50% of the weight resting on the coulter 50, more preferably between 75% and 90% of the weight resting on the coulter sealers 176, 178, and between 5% and 20% of the weight resting on the coulter 50, and most preferably about 87.5% of the weight resting on the coulter sealers 176, 178, and about 12.5% of the weight resting on the coulter 50. Preferably, the weight is evenly distributed between the coulter sealers 176, 178, but may be distributed more on one of the coulter sealers 176, 178 than the other. Resting a majority of the weight on the coulter sealers 176, 178 controls the depth of the product being applied, reduces plugging of soil between the coulter sealers 176, 178 in high residue conditional, and facilitates the sealing of the product under the soil. The offset between the coulter sealers 176, 178 also reduces plugging of soil between the coulter sealers 176, 178 and facilitates the sealing of the product under the soil.

The nuts 116, 118, 136, 138 are adjusted to provide sufficient down force on the coulter 50, knife 120, and coulter sealers 176, 178, while reducing vibration in these elements and allowing these elements to move out of the way in response to striking an obstruction, as opposed to bending or breaking on the obstruction. In the event the coulter 50 encounters an obstruction such as a rock or log, the applicator assembly 24 pivots upward against the plates 36, 38, allowing the coulter 50 to ride over the top of the obstruction. When the knife 120 encounters an obstruction, the knife plates 76, 78 rotate upward, compressing the springs 100, 102, allowing the knife 120 to move upward and over the obstruction. Once the knife 120 has cleared the obstruction, the springs 100, 102 bias the knife 120 back downward into the soil.

When the coulter sealers 176, 178 encounter an obstruction, the drop bars 156, 158 pivot upward, causing the shafts 132, 132 to move forward, compressing the springs 140, 142. Once the coulter sealers 176, 178 have cleared the obstruction, the springs 140, 142 force the drop bars 156, 158 back downward and forcing the coulter sealers 176, 178 back into the soil. Given the construction of the coulter sealers 176, 178, the coulter sealers 176, 178 are designed to move upward and out of the way of obstructions independently of one another. This allows one coulter sealer 176, 178 to continue to move soil over the furrow even if the other coulter sealer 176, 178 has been obstructed.

Although the invention has been described with respect to a preferred embodiment thereof, it is to be understood that it is not to be so limited, since changes and modifications can be therein which are within the full intended scope of this invention, as defined by the appended claims. For example, any number of applicator assemblies may be provided in any desired orientation on a frame. It is additionally anticipated that the agricultural material applicator may be used in association with herbicides, pesticides, and any desired or known type of soil nutrient. It is also to be understood that any known type of soil disrupter may be used in place of the coulter 50 or knife 120, and that any type of sealer may be used in place of the coulter sealers 176, 178.

What is claimed is:

1. A system for applying material to soil comprising:
a) a frame;
b) a soil disrupter coupled to the frame;
c) a soil sealer coupled to the frame;
d) a material dispenser coupled to the frame, wherein the material dispenser is positioned between the soil disrupter and the soil sealer;
e) wherein the soil sealer is of a construction sufficient to prevent the soil sealer from penetrating the soil beyond a predetermined depth.

2. The system of claim 1 further comprising soil sealer shock absorber coupled to the soil sealer.

3. The system of claim 2 further comprising a material dispenser shock absorber coupled to the material dispenser.

4. The system of claim 1 further comprising a material dispenser shock absorber coupled to the material dispenser.

5. The system of claim 1 wherein the soil sealer is journaled to the frame.

6. The system of claim 5 wherein the soil sealer is a wavy coulter.

7. The system of claim 5 wherein the soil sealer is a spiral directional wavy coulter.

8. The system of claim 1 wherein the soil sealer comprises:
a) a first wheel journaled to the frame; and
b) a second wheel journaled to the frame.

9. The system of claim 8 wherein the first wheel is behind the second wheel.

10. The system of claim 1 wherein the soil sealer comprises:
a first coulter journaled to the frame; and
a second coulter journaled to the frame.

11. The system of claim 10 wherein the first coulter is wavy, spiral and directional.

12. The system of claim 10 further comprising:
a first shock absorber coupled to the first coulter; and
a second shock absorber coupled to the second coulter.

13. The system of claim 12 wherein the first shock absorber operates independently of the second shock absorber.

14. A system for applying material to soil comprising:
a) a frame;
b) a soil disrupter coupled to the frame;
c) a material dispenser coupled to the frame;
d) a soil sealer coupled to the frame, the soil sealer comprising:
i) a first wheel journaled to the frame;
ii) a second wheel journaled to the frame; and
e) wherein a weight equal to at least 40% of the weight of the frame, the soil disrupter, and the material dispenser is supported by the soil sealer.

15. The system of claim 14, wherein a line defined by the soil disrupter and the material dispenser passes between the first wheel and the second wheel.

16. The system of claim 14, wherein a weight equal to at least 70% of the weight of the frame, the soil disrupter, and the material dispenser is supported by the soil sealer.

17. The system of claim 14, further comprising a first shock absorber coupled to the first wheel and a second shock absorber coupled to the second wheel.

18. The system of claim 17, wherein the first shock absorber operates independently of the second shock absorber.

19. A system for applying a fluid material to soil comprising:
a) a toolbar;
b) a soil disrupter assembly;
c) a parallel linkage coupled between the tool bar and the soil disrupter assembly;
d) a frame coupled to the soil disrupter assembly;
e) a fluid material dispenser coupled to the frame;
f) a first coulter sealer journaled to the frame;
g) a second coulter sealer journaled to the frame;
h) wherein a weight equal to at least 25% of the weight of the frame, the soil disrupter, and the material dispenser is supported by the first coulter sealer; and
i) wherein a weight equal to at least 25% of the weight of the frame, the soil disrupter, and the material dispenser is supported by the second coulter sealer.

20. The system of claim 19, wherein a weight equal to at least 35% of the weight of the frame, the soil disrupter, and the material dispenser is supported by the first coulter sealer; and wherein a weight equal to at least 35% of the weight of the frame, the soil disrupter, and the material dispenser is supported by the second coulter sealer.
